(19) United States
(12) Patent Application Publication
(10) Pub. No.: US 2003/0079929 A1
(43) Pub. Date: May 1, 2003

(54) Apparatus for detecting head of occupant in vehicle

(76) Inventors: Akira Takagi, Nagoya (JP); Masayuki Imanishi, Okazaki-shi (JP); Hisanaga Matsuoka, Okazaki-shi (JP); Tomoyuki Goto, Anjo-shi (JP); Hironori Sato, Nishio-shi (JP)

Correspondence Address: POSZ & BETHARDS, PLC, 11250 ROGER BACON DRIVE, SUITE 10, RESTON, VA, 20190, US

(21) Appl. No.: 10/268,956

(22) Filed: Oct. 11, 2002

(30) Foreign Application Priority Data
Oct. 31, 2001 (JP) 2001-334512

(51) Int. Cl. B60R 21/00

(52) U.S. Cl. 180/274

(57) ABSTRACT

An apparatus for detecting the head of an occupant in a seat within a vehicle includes an area image sensor for periodically taking an image of an area including the occupant in the seat, and outputting a signal sequentially representing 1-frame images of the area. A head position calculating section operates for deciding a position of a head of the occupant on the basis of the 1-frame images sequentially represented by the signal outputted by the area image sensor. The head position calculating section includes a device for calculating motion quantities of portions of each of the 1-frame images, a device for detecting, in each of the 1-frame images, a maximum-motion image region in which portions having substantially largest one among the calculated motion quantities collect to a highest degree, and a device for recognizing the detected maximum-motion image region as corresponding to the head of the occupant.

### BACKGROUND OF THE INVENTION

1. Field of the Invention

This invention relates to an apparatus for detecting the head of an occupant in a vehicle such as an automotive vehicle.

2. Description of the Related Art

A known apparatus for protecting an occupant in a vehicle includes a pair of area image sensors located near a vehicle windshield and facing an area on a vehicle seat. The area image sensors are spaced at a prescribed interval along the widthwise direction (the transverse direction) of the vehicle. The area image sensors take images of the area on the vehicle seat, and output signals representing the taken images. In the known apparatus, the image-representing signals are processed to detect the positions of portions of an occupant on the seat. The detected positions are defined along the lengthwise direction (the longitudinal direction) of the vehicle. The mode of the control of deployment of an air bag is changed in response to the detected positions of the portions of the occupant.

In the known apparatus, shifts between corresponding portions of the images taken by the area image sensors are detected, and the positions of portions of an occupant in the vehicle are measured from the detected shifts on a triangulation basis. When the known apparatus is used to detect the position of the head of an occupant in the vehicle, the following problem may occur. The position of occupant's hand or a thing in front of occupant's head is erroneously detected as the position of occupant's head. In the known apparatus, the triangulation-based detection of the positions of portions of an occupant in the vehicle requires the two area image sensors, and includes complicated image-signal processing which causes a longer signal processing time.

Japanese patent application publication number P2000-113164A discloses an on-vehicle apparatus for detecting an object in response to a difference image. The apparatus in Japanese application P2000-113164A includes an image capture device for repetitively taking an image of an object. For a same object, a first edge image is extracted from an image signal from the image capture device at a first moment, and a second edge image is extracted therefrom at a second moment after the first moment. The difference between the first edge image and the second edge image is calculated to generate a difference image. Specifically, for each of pairs of corresponding pixels composing the first edge image and the second edge image, the inter-pixel difference value is calculated. During the calculation of the difference between the first edge image and the second edge image, corresponding pixels in a pair which are equal in value are canceled. Therefore, stationary image portions are removed from the difference image. Only moving image portions remain as the difference image. Thus, edge image portions of stationary backgrounds such as a seat and a door of a vehicle are erased while only edge image portions of a moving occupant in the vehicle are extracted. Accordingly, it is possible to efficiently get information about the state and position of a moving object such as a moving occupant in the vehicle.

Japanese patent application publication number 3-71273 discloses an adaptive head position detector which functions to detect data with a highly accurate moving variable by switching an operation expression based upon plural head models in accordance with the shape pattern of a head in the case of calculating rotational angle and parallel movement of a person having a complex shape standing in the front of a camera. The adaptive head position detector includes a first approximate processing part in which a first head approximate processing part extracts the outline of the head from a differential image and a first head approximate model adaptive part approximately adapts a model for a head outline graphic. The adaptive head position detector further includes a second approximate processing part in which a second head approximate processing part approximately finds out the shape of a boundary between a hair area and a face area and a second head approximate model adaptive part adapts a head image to the head model including the boundary. The operation expression for calculating the models of the head part in respective directions and their moving variables can be adaptively found out by an adaptive calculation expression processing part, and the rotational angle and parallel movement of the head part can be found out by a head part position detecting processing part.

### SUMMARY OF THE INVENTION

It is an object of this invention to provide an improved apparatus for detecting the head of an occupant in a vehicle such as an automotive vehicle.

A first aspect of this invention provides an apparatus for detecting the head of an occupant in a seat within a vehicle. The apparatus comprises an area image sensor for periodically taking an image of an area including the occupant in the seat, and outputting a signal sequentially representing 1-frame images of the area; and a head position calculating section for deciding a position of a head of the occupant on the basis of the 1-frame images sequentially represented by the signal outputted by the area image sensor; wherein the head position calculating section includes means for calculating motion quantities of portions of each of the 1-frame images, means for detecting, in each of the 1-frame images, a maximum-motion image region in which portions having substantially largest one among the calculated motion quantities collect to a highest degree, and means for recognizing the detected maximum-motion image region as corresponding to the head of the occupant.

A second aspect of this invention is based on the first aspect thereof, and provides an apparatus wherein the head position calculating section includes means for calculating a difference between current one and immediately preceding one among the 1-frame images to generate a difference 1-frame image as an indication of the calculated motion quantities of portions of each of the 1-frame images, means for detecting a motion quantity distribution condition of the difference 1-frame image, and means for detecting the maximum-motion image region in response to the detected motion quantity distribution condition of the difference 1-frame image.

A third aspect of this invention is based on the first aspect thereof, and provides an apparatus wherein the head position calculating section includes means for extracting image portions from each of the 1-frame images, means for calculating motion vectors regarding the extracted image portions respectively and defined between current one and immediately preceding one among the 1-frame images as an indication of the calculated motion quantities of portions of each of the 1-frame images, means for detecting a condition of a distribution of the calculated motion vectors over one frame, and means for detecting the maximum motion image region in response to the detected motion vector distribution condition.

A fourth aspect of this invention is based on the first aspect thereof, and provides an apparatus wherein the head position calculating section includes means for dividing and shaping a two-dimensional distribution pattern of the calculated motion quantities into an arrangement pattern of image blocks corresponding to respective portions of the occupant, means for collating the arrangement pattern with predetermined reference patterns corresponding to different occupant postures to detect which of the predetermined reference patterns the arrangement pattern best matches, and means for deciding a longitudinal-direction position of the head of the occupant in response to the predetermined reference pattern which best matches the arrangement pattern.

A fifth aspect of this invention is based on the first aspect thereof, and provides an apparatus wherein the area image sensor is in front of the seat, and the head position calculating section includes means for deriving a height-direction position of the head of the occupant, means for deciding a degree of forward lean of the occupant in response to the derived height-direction position of the head of the occupant, and means for deciding a longitudinal-direction position of the head of the occupant in response to the decided degree of forward lean of the occupant.

A sixth aspect of this invention is based on the first aspect thereof, and provides an apparatus wherein the head position calculating section includes means for averaging the calculated motion quantities into mean motion quantities over a prescribed number of successive frames according to a cumulative procedure, means for detecting a maximum-motion image region in which portions having substantially largest one among the mean motion quantities collect to a highest degree, and means for recognizing the detected maximum-motion image region as corresponding to the head of the occupant.

A seventh aspect of this invention provides an apparatus for detecting the head of an occupant in a seat within a vehicle. The apparatus comprises an area image sensor for periodically taking an image of an area including the occupant in the seat, and outputting a signal sequentially representing 1-frame images of the area; and a head position calculating section for deciding a position of a head of the occupant on the basis of the 1-frame images sequentially represented by the signal outputted by the area image sensor; wherein the head position calculating section includes means for calculating a difference between current one and immediately preceding one among the 1-frame images to generate a difference 1-frame image as an indication of a two-dimensional distribution pattern of the calculated motion quantities of portions of each of the 1-frame images, means for dividing and shaping the two-dimensional distribution pattern into an arrangement pattern of image blocks corresponding to respective portions of the occupant, means for collating the arrangement pattern with predetermined reference patterns corresponding to different occupant postures to detect which of the predetermined reference patterns the arrangement pattern best matches, and means for deciding a longitudinal-direction position of the head of the occupant in response to the predetermined reference pattern which best matches the arrangement pattern.

An eighth aspect of this invention provides an apparatus for detecting the head of an occupant in a seat within a vehicle. The apparatus comprises an area image sensor for periodically taking an image of an area including the occupant in the seat, and outputting a signal sequentially representing 1-frame images of the area; and a head position calculating section for deciding a position of a head of the occupant on the basis of the 1-frame images sequentially represented by the signal outputted by the area image sensor; wherein the head position calculating section includes means for extracting image portions from each of the 1-frame images, means for calculating motion vectors regarding the extracted image portions respectively and defined between current one and immediately preceding one among the 1-frame images, means for detecting a two-dimensional distribution pattern of the calculated motion vectors, means for dividing and shaping the two-dimensional distribution pattern into an arrangement pattern of image blocks corresponding to respective portions of the occupant, means for collating the arrangement pattern with predetermined reference patterns corresponding to different occupant postures to detect which of the predetermined reference patterns the arrangement pattern best matches, and means for deciding a longitudinal-direction position of the head of the occupant in response to the predetermined reference pattern which best matches the arrangement pattern.

A ninth aspect of this invention is based on the second aspect thereof, and provides an apparatus wherein the head position calculating section includes means for averaging a prescribed number of successive difference 1-frame images into a mean difference 1-frame image according to a cumulative procedure, means for detecting a motion quantity distribution condition of the mean difference 1-frame image, and means for detecting the maximum-motion image region in response to the detected motion quantity distribution condition of the mean difference 1-frame image.

A tenth aspect of this invention is based on the third aspect thereof, and provides an apparatus wherein the head position calculating section includes means for averaging the calculated motion vectors into mean motion vectors over a prescribed number of successive frames according to a cumulative procedure, means for detecting a condition of a distribution of the mean motion vectors over one frame, and means for detecting the maximum-motion image region in response to the detected mean motion vector distribution condition.

### BRIEF DESCRIPTION OF THE DRAWINGS

FIG. 1 is a diagrammatic side view of a portion of a vehicle which includes an apparatus for detecting the head of an occupant in the vehicle according to a first embodiment of this invention.

FIG. 2 is a diagrammatic plan view of an occupant sensor and an assistant driver's seat in FIG. 1.

FIG. 3 is a block diagram of a controller in FIG. 1.

FIG. 4 is a time-domain diagram showing an example of the waveform of a horizontal scanning line signal having an order number Nm and relating to a current 1-frame image F1, the waveform of a horizontal scanning line signal having the same order number Nm and relating to an immediately-preceding 1-frame image F2, and the waveform of a horizontal scanning line signal having the same order number Nm and relating to a difference 1-frame image ΔF1 which occur when an occupant in the vehicle is moving leftward or rightward.

FIG. 5 is a diagram of an example of the difference 1-frame image ΔF1.

FIG. 6 is a diagrammatic side view showing the relation between the height position of the head of a typical occupant in the vehicle and the degree of forward lean of the upper part of the typical occupant.

FIG. 7 is a diagram of an example of a block pattern in a difference 1-frame image ΔF1 in a second embodiment of this invention.

FIG. 8 is a flowchart of a segment of a control program for a microcomputer in a sixth embodiment of this invention.

FIG. 9 is a flowchart of a portion of a control program for a microcomputer in a seventh embodiment of this invention.

### DETAILED DESCRIPTION OF THE INVENTION

### First Embodiment

A first embodiment of this invention relates to an apparatus for detecting the head of an occupant in a vehicle such as an automotive vehicle. The head detecting apparatus is designed so that motions of blocks (regions) composing one frame are detected on the basis of the difference between successive 1-frame images, and one among the blocks (regions) which has the great motion is recognized as a head of the occupant in the vehicle.

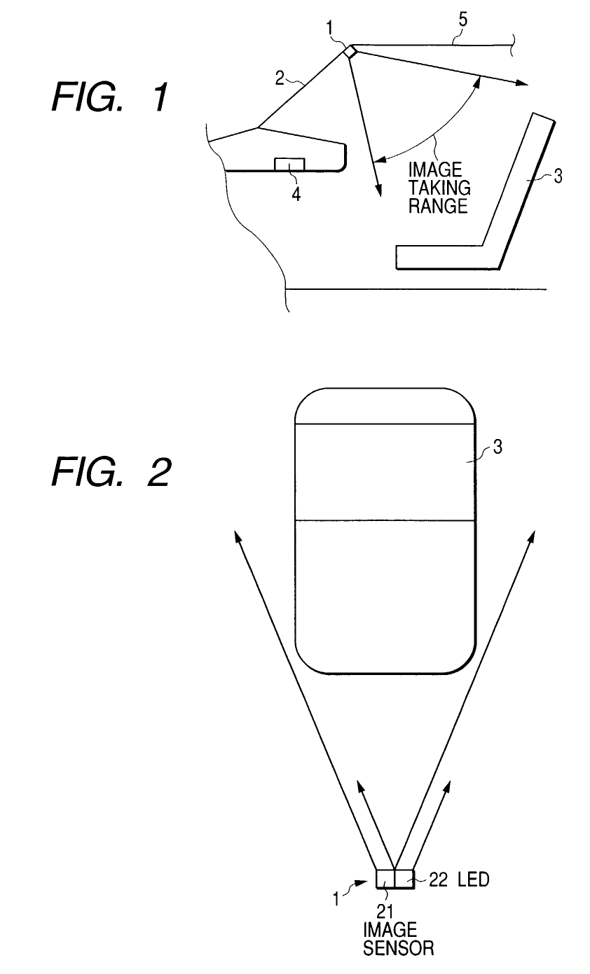

FIG. 1 shows a system for protecting an occupant in a vehicle (for example, an automotive vehicle) which includes the head detecting apparatus of the first embodiment of this invention. With reference to FIG. 1, an occupant sensor 1 is fixed to an upper portion of the windshield 2 of the vehicle. The occupant sensor 1 faces an area on an assistant driver's seat 3 of the vehicle. The occupant sensor 1 periodically takes an image of the area on the assistant driver's seat 3. The occupant sensor 1 outputs a signal representing the taken image.

It should be noted that the occupant sensor 1 may face an area on a main driver's seat of the vehicle and periodically take an image of that area.

A controller 4 disposed in an interior of an instrument panel assembly or a console panel assembly of the vehicle processes the output signal of the occupant sensor 1. The controller 4 controls inflation or deployment of an air bag in response to the processing results and also an output signal of a collision sensor. The body of the vehicle has a ceiling 5.

With reference to FIG. 2, the occupant sensor 1 includes an infrared area image sensor 21 and an infrared LED (light-emitting diode) 22. The infrared area image sensor 21 is fixed to a given part of the vehicle body which includes the upper portion of the windshield 2 and the front edge of the ceiling 5. The infrared area image sensor 21 has a relatively wide field angle. The infrared area image sensor 21 periodically takes an image of a scene including the assistant driver's seat 3. In other words, the infrared area image sensor 21 periodically takes an image of an area on the assistant driver's seat 3. The infrared area image sensor 21 outputs a signal (data) representing the taken image. The infrared LED 22 is used as a light source.

The infrared area image sensor 21 and the infrared LED 22 are adjacent to each other. The infrared area image sensor 21 and the infrared LED 22 have respective optical axes which are in planes vertical with respect to the vehicle body and parallel to the lengthwise direction (the longitudinal direction) of the vehicle. The optical axes of the infrared area image sensor 21 and the infrared LED 22 are in downward slant directions or downward slope directions as viewed therefrom.

The infrared area image sensor 21 has an array of 1-pixel regions integrated on a semiconductor substrate. The infrared LED 22 is intermittently activated at regular intervals. The duration of every activation of the infrared LED 22 is equal to a prescribed time length. Immediately before the start of every activation of the infrared LED 22, stored charges are transferred from the 1-pixel regions of the infrared area image sensor 21 to the semiconductor substrate. Simultaneously with the end of every activation of the infrared LED 22, the infrared area image sensor 21 sequentially outputs 1-pixel signals which depend on the transferred charges. The order of the outputting of the 1-pixel signals is accorded with normal line-by-line scan. Thus, during every horizontal scanning period, 1-pixel signals representing one horizontal scanning line are sequentially outputted. A horizontal blanking period having a prescribed time length is provided between two successive horizontal scanning periods.

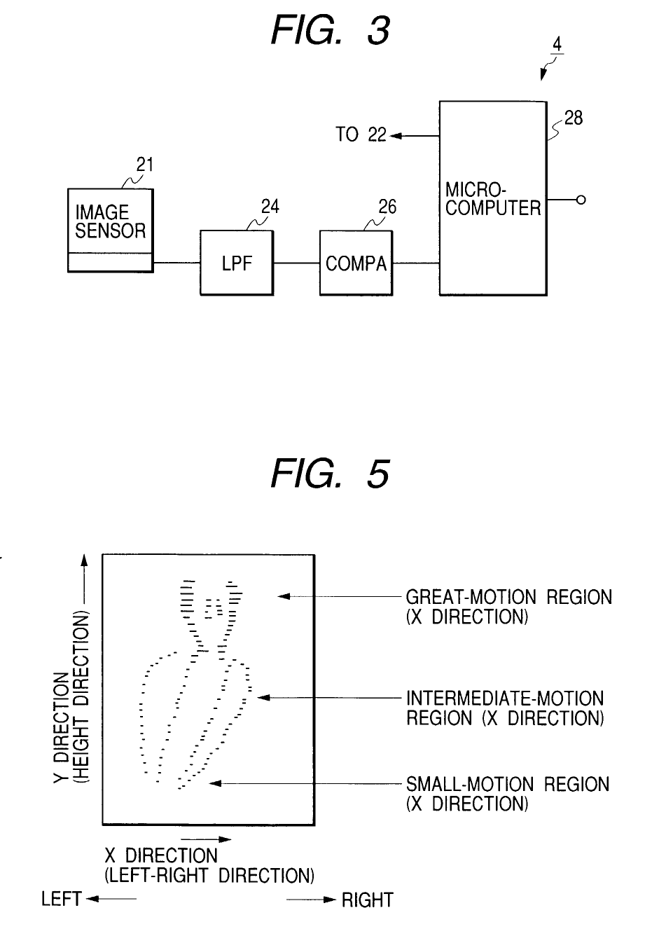

As shown in FIG. 3, the controller 4 includes a low pass filter 24, a comparator 26, and a microcomputer 28. The low pass filter 24 is connected to the infrared area image sensor 21. The low pass filter 24 is successively followed by the comparator 26 and the microcomputer 28. The microcomputer 28 is also connected with the infrared LED 22.

The low pass filter 24 extracts low-frequency components from an image signal outputted by the infrared area image sensor 21. The low pass filter 24 outputs the resultant image signal to the comparator 26. The device 26 compares the output signal of the low pass filter 24 with a prescribed threshold level, and thereby converts the output signal of the low pass filter 24 into a binary image signal (image data). The comparator 26 outputs the binary image signal to the microcomputer 28. The microcomputer 28 processes the output signal of the comparator 26. In addition, the microcomputer 28 intermittently activates the infrared LED 22 at regular intervals.

Motion of an occupant in the vehicle is detected on the basis of the difference between two successive 1-frame images represented by the output signal of the infrared area image sensor 21. In the presence of a fine vertical-stripe pattern in successive 1-frame images, there is a chance that same image portions overlap and hence motion can not be detected. To prevent the occurrence of such a problem, the low pass filter 24 removes high-frequency components from the output signal (the horizontal scanning line signal) of the infrared area image sensor 21. Thus, the low pass filter 24 outputs only horizontal-direction low-frequency components in the horizontal scanning line signal to the comparator 26. The comparator 26 converts the low-frequency signal components into the binary image signal. The comparator 26 outputs the binary image signal (the image data) to the microcomputer 28. Every pixel represented by the binary image signal is in either a state of “black (dark)” or a state of “white (bright)”.

The microcomputer 28 includes a combination of an input/output port, a CPU, a ROM, and a RAM. The microcomputer 28 operates in accordance with a control program stored in the ROM or the RAM. The control program is designed to enable the microcomputer 28 to implement operation steps mentioned later.

The microcomputer 28 processes the image data outputted from the comparator 26. The processing of the image data by the microcomputer 28 includes a process of calculating the difference between a current 1-frame image F1 and an immediately-preceding 1-frame image F2 represented by the image data to generate a difference 1-frame image ΔF1. Every frame represented by the image data is composed of a prescribed number of horizontal scanning lines. Serial order numbers (serial identification numbers) Nm are assigned to signals in the image data which represent the respective horizontal scanning lines composing one frame, respectively. During every 1-line-corresponding stage of the previously-mentioned difference calculating process, computation is given of the difference between related horizontal scanning line signals having equal order numbers (equal identification numbers) Nm. Every difference 1-frame image ΔF1 is also represented by horizontal scanning line signals having serial order numbers (serial identification numbers) Nm.

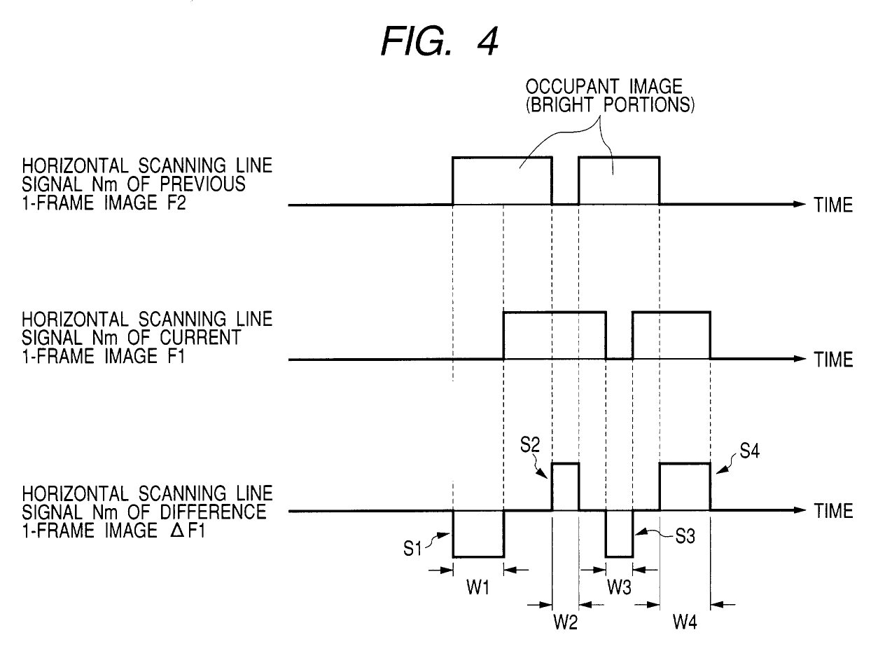

FIG. 4 shows an example of the waveform of a horizontal scanning line signal having an order number Nm and relating to the current 1-frame image F1, the waveform of a horizontal scanning line signal having the same order number Nm and relating to the immediately-preceding 1-frame image F2, and the waveform of a horizontal scanning line signal having the same order number Nm and relating to the difference 1-frame image ΔF1 which occur when an occupant in the vehicle is moving leftward or rightward.

With reference to FIG. 4, the horizontal scanning line signal having the order number Nm and relating to the difference 1-frame image ΔF1 contains difference image region signals S1, S2, S3, and S4 having widths W1, W2, W3, and W4 respectively and representing horizontally extended contour segments of an occupant image respectively. The difference image region signals S1, S2, S3, and S4 are temporally spaced from each other. For regions in a 1-frame image where motion of an occupant (an object to be measured) in the vehicle is great, difference image region signals having large widths are caused. For regions in a 1-frame image where motion of an occupant in the vehicle is small, difference image region signals having small widths are caused. For regions in a 1-frame image where an occupant in the vehicle is stationary, difference image region signals are absent.

In the case where external light considerably varies as the vehicle travels, a great change tends to occur in the result of the previously-mentioned difference calculating process. Such a great change can be removed or separated by suitable filtering. In general, the great change is temporary or momentary. Therefore, the affection of the great change can be reduced by a motion cumulative procedure mentioned later.

FIG. 5 shows an example of the difference 1-frame image ΔF1 which occurs when the upper part of an occupant in the vehicle is swinging leftward and rightward about the waist. In FIG. 5, a height direction (a vertical direction) is defined as a Y direction while a transverse direction (a left-right direction) is defined as an X direction. It is understood from FIG. 5 that many difference image region signals having large widths collect in time ranges corresponding to the head of the occupant, and that difference image region signals having large widths hardly exist in time ranges corresponding to the other parts of the occupant.

Image data representing every frame may be divided into signals corresponding to vertical lines composing the frame. In this case, during every 1-line-corresponding stage of the difference calculating process, computation is given of the difference between related vertical line signals having equal order numbers (equal identification numbers). Every difference 1-frame image ΔF1 is also represented by vertical line signals having serial order numbers (serial identification numbers). The vertical line signals relating to the difference 1-frame image ΔF1 contain difference image region signals having widths which increase in accordance with vertical motion of an occupant in the vehicle.

Image data representing every frame may be divided into signals corresponding to oblique lines composing the frame. In this case, during every 1-line-corresponding stage of the difference calculating process, computation is given of the difference between related oblique line signals having equal order numbers (equal identification numbers). Every difference 1-frame image ΔF1 is also represented by oblique line signals having serial order numbers (serial identification numbers). The oblique line signals relating to the difference 1-frame image ΔF1 contain difference image region signals having widths which increase in accordance with oblique motion of an occupant in the vehicle.

In the case where the back of an occupant in the vehicle is stretched along a vertical direction, many difference image region signals having large widths collect in time ranges corresponding to the head of the occupant. Furthermore, in the case where the upper part of an occupant in the vehicle is moving obliquely, many difference image region signals having large widths collect in time ranges corresponding to the head of the occupant.

The microcomputer 28 searches the difference 1-frame image ΔF1 for a region corresponding to time ranges where difference image region signals having widths equal or substantially equal to the largest width collect to the highest degree. In other words, the microcomputer 28 detects a region in the difference 1-frame image ΔF1 which corresponds to time ranges where difference image region signals having widths equal or substantially equal to the largest width collect to the highest degree. The microcomputer 28 recognizes the detected image region as the head of an occupant in the vehicle.

The microcomputer 28 may search the difference 1-frame image ΔF1 for a region corresponding to time ranges where more than a given number of difference image region signals having widths equal or substantially equal to the largest width collect. In other words, the microcomputer 28 may detect a region in the difference 1-frame image ΔF1 which corresponds to time ranges where more than a given number of difference image region signals having widths equal or substantially equal to the largest width collect. The microcomputer 28 recognizes the detected image region as the head of an occupant in the vehicle.

The microcomputer 28 may use only difference image region signals in horizontal scanning line signals for the detection of the head of an occupant in the vehicle. In this case, the processing of the image data by the microcomputer 28 can be simple, and only leftward motion, rightward motion, rotation, or swing of the head of the occupant can be extracted.

Preferably, the processing of the image data by the microcomputer 28 includes a process of preventing motion of a hand of an occupant in the vehicle from adversely affecting the detection of the head of the occupant. Specifically, the microcomputer 28 averages a prescribed number of successive difference 1-frame images (the current difference 1-frame image ΔF1 and previous difference 1-frame images) into a mean difference 1-frame image according to a cumulative procedure. The microcomputer 28 processes the mean difference 1-frame image to detect the head of an occupant in the vehicle. It is usual that the head of an occupant in the vehicle frequently swings leftward and rightward for a relatively long term. Therefore, regarding the mean difference 1-frame image, many difference image region signals having large widths tend to collect in time ranges corresponding to the head of the occupant. The microcomputer 28 searches the mean difference 1-frame image for a region corresponding to time ranges where difference image region signals having widths equal or substantially equal to the largest width collect to the highest degree. In other words, the microcomputer 28 detects a region in the mean difference 1-frame image which corresponds to time ranges where difference image region signals having widths equal or substantially equal to the largest width collect to the highest degree. The microcomputer 28 recognizes the detected image region as the head of an occupant in the vehicle. Difference image region signals relating to the current difference 1-frame image ΔF1 and having large widths are caused by short-term motion of a hand of an occupant in the vehicle. The use of the mean difference 1-frame image prevents the short-term motion of the occupant's hand from adversely affecting the detection of the occupant's head.

Generally, a hand of an occupant in the vehicle has an elongated shape in comparison with the head of the occupant. Accordingly, the microcomputer 28 may remove an elongated-shape image region in the difference 1-frame image ΔF1 from the detection of occupant's head. In this case, it is possible to prevent motion of a hand of the occupant from adversely affecting the detection of the occupant's head. Generally, there is only a small chance that a hand of an occupant in the vehicle is moving during the inflation or deployment of the air bag. Accordingly, it is unnecessary to provide a process of preventing motion of a hand of an occupant in the vehicle from adversely affecting the detection of the head of the occupant during the inflation or deployment of the air bag.

As previously mentioned, the microcomputer 28 detects a region in the difference 1-frame image ΔF1 which corresponds to time ranges where difference image region signals having widths equal or substantially equal to the largest width collect to the highest degree. The microcomputer 28 recognizes the detected image region as the head of an occupant in the vehicle. Thus, a simple structure and simple signal processing enable the head of an occupant in the vehicle to be accurately and easily detected.

In some cases, the detected image region corresponding to the head of an occupant in the vehicle occupies a relatively-large area within the difference 1-frame image ΔF1. The microcomputer 28 calculates the coordinate position of the centroid or the center of the relatively-large detected image region corresponding to the occupant's head. The microcomputer 28 decides the representative coordinate position of the occupant's head in accordance with the calculated coordinate position of the centroid or the center of the relatively-large detected image region.

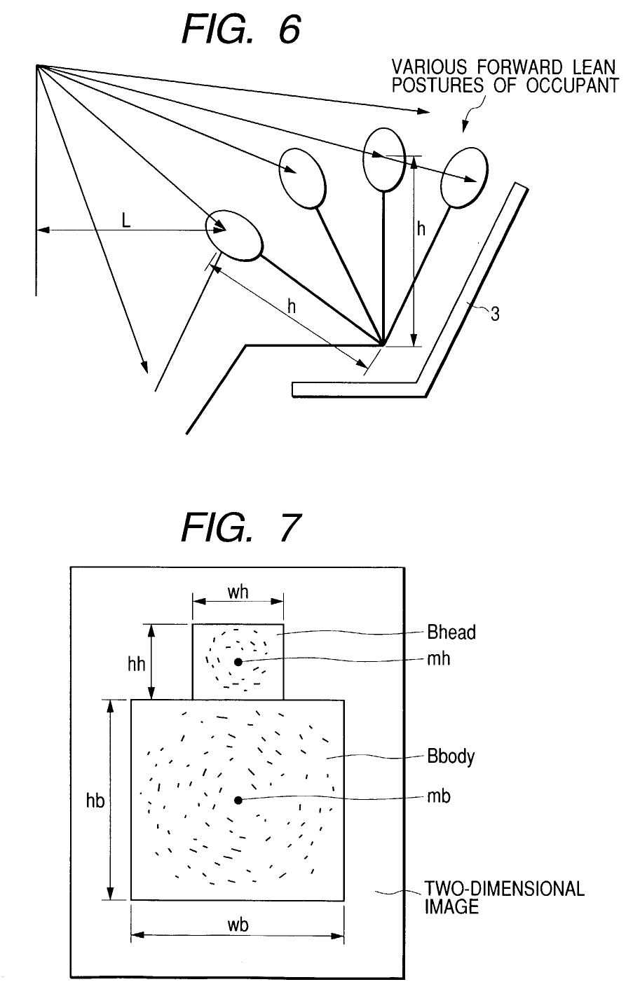

The microcomputer 28 calculates the position of the occupant's head in the lengthwise direction (the longitudinal direction) of the vehicle as follows. With reference to FIG. 6, the infrared area image sensor 21 periodically takes an image of an occupant in the assistant driver's seat 3 from a viewpoint in front of the occupant. In the case where the occupant sits upright on the assistant driver's seat 3, the coordinate position of the relatively-large detected image region corresponding to the occupant's head is the highest in the Y direction (the height direction). The microcomputer 28 detects when the coordinate position of the relatively-large detected image region corresponding to the occupant's head becomes the highest in the Y direction. The microcomputer 28 estimates the height “h” of the upper part of the occupant from the detected highest coordinate position of the relatively-large detected image region corresponding to the occupant's head. The microcomputer 28 holds data representative of the estimated occupant's height “h”. The microcomputer 28 stores, in advance, data representing a predetermined relation between the height position of the head of a typical occupant in the vehicle and the degree of forward lean of the upper part of the typical occupant. The microcomputer 28 estimates the current degree of forward lean of the upper part of the occupant from the current Y-direction coordinate position (the height position) of the occupant's head by referring to the previously-mentioned relation. The microcomputer 28 calculates the current longitudinal-direction position of the occupant's head from the estimated occupant's height “h” and the estimated current degree of forward lean of the upper part of the occupant. Regarding the calculation of the current longitudinal-direction position of the occupant's head, the microcomputer 28 supposes that the upper part of the occupant swings about the waist.

### Second Embodiment

A second embodiment of this invention is similar to the first embodiment thereof except for design changes mentioned hereafter.

In a typical two-dimensional image, a first region having great motion and being small in size (horizontal width or transverse width) corresponds to the head of an occupant in the vehicle while a second region having small motion, and being large in size (horizontal width or transverse width) and extending below the first region corresponds to the body (the breast and the belly) of the occupant.

With reference to FIG. 7, the microcomputer 28 defines rectangular blocks “Bhead” and “Bbody” in a difference 1-frame image ΔF1. The rectangular block “Bhead” corresponds to the head of an occupant in the vehicle. The rectangular block “Bhead” is also referred to as the head-corresponding block “Bhead”. The rectangular block “Bbody” corresponds to the body of the occupant. The rectangular block “Bbody” is also referred to as the body-corresponding block “Bbody”. Specifically, a rectangular region in a difference 1-frame image ΔF1 which has great motion and which is small in size (horizontal width or transverse width) is defined as a head-corresponding block “Bhead”. On the other hand, a rectangular region in the difference 1-frame image ΔF1 which has small motion, which is large in size (horizontal width or transverse width), and which extends below the head-corresponding block “Bhead” is defined as a body-corresponding block “Bbody”. In FIG. 7: the character “mh” denotes the center point of the head-corresponding block “Bhead”; the character “mb” denotes the center point of the body-corresponding block “Bbody”; “wh” denotes the transverse width (the horizontal width) of the head-corresponding block “Bhead”; “wb” denotes the transverse width (the horizontal width) of the body-corresponding block “Bbody”; “hh” denotes the height of the head-corresponding block “Bhead”; and “hb” denotes the height of the body-corresponding block “Bbody”.

As the upper part of an occupant in the vehicle leans forward, the area of the head-corresponding block “Bhead” increases. Specifically, as the upper part of an occupant in the vehicle leans forward, the transverse width “wh” and the height “hh” of the head-corresponding block “Bhead” increase. On the other hand, as the upper part of an occupant in the vehicle leans forward, the area and the height “hb” of the body-corresponding block “Bbody” decrease. The microcomputer 28 stores, in advance, data representing a map which shows a predetermined relation of these parameters (the area of a head-corresponding block “Bhead”, the transverse width “wh” of the head-corresponding block “Bhead”, the height “hh” of the head-corresponding block “Bhead”, the area of a body-corresponding block “Bbody”, and the height “hb” of the body-corresponding block “Bbody”) with various postures of a typical occupant in the vehicle. The microcomputer 28 calculates the current posture of an occupant in the vehicle from the current values of the parameters by referring to the previously-mentioned map. The various postures in the map include postures corresponding to different degrees of forward lean of the upper part of the typical occupant. The various postures may further include postures corresponding to different degrees of forward lean of only the neck of the typical occupant.

The microcomputer 28 stores, in advance, data representing various reference patterns of a head-corresponding block “Bhead” and a body-corresponding block “Bbody”. The microcomputer 28 stores, in advance, data representing different degrees of forward lean of the upper part of the typical occupant which are assigned to the different reference block patterns (the different reference patterns of the head-corresponding block “Bhead” and the body-corresponding block “Bbody”) respectively. The microcomputer 28 sequentially compares or collates a current block pattern (see FIG. 7) with the reference block patterns, and decides one among the reference block patterns which best matches the current block pattern. The microcomputer 28 detects the degree of forward lean of the upper part of the typical occupant which is assigned to the best-match reference block pattern. The microcomputer 28 calculates the current longitudinal-direction position of occupant's head from the detected degree of forward lean of the upper part of the typical occupant.

Preferably, the microcomputer 28 implements normalization to prevent the calculated longitudinal-direction position of occupant's head from being adversely affected by occupant's size. The normalization utilizes the ratio in area between a head-corresponding block “Bhead” and a body-corresponding block “Bbody” or a ratio in height between the head-corresponding block “Bhead” and the body-corresponding block “Bbody” as a comparison parameter.

### Third Embodiment

A third embodiment of this invention is similar to the second embodiment thereof except for design changes mentioned hereafter.

According to the third embodiment of this invention, the microcomputer 28 disregards the magnitude of motion in defining a head-corresponding block “Bhead” and a body-corresponding block “Bbody” in a difference 1-frame image ΔF1. Specifically, a rectangular region in a difference 1-frame image ΔF1 which is small in size (horizontal width or transverse width) is defined as a head-corresponding block “Bhead”. On the other hand, a rectangular region in the difference 1-frame image ΔF1 which is large in size (horizontal width or transverse width), and which extends below the head-corresponding block “Bhead” is defined as a body-corresponding block “Bbody”.

### Fourth Embodiment

A fourth embodiment of this invention is similar to the first embodiment thereof except for design changes mentioned hereafter.

According to the fourth embodiment of this invention, the microcomputer 28 divides every 1-frame image represented by the image data into image regions. For each of the image regions, the microcomputer 28 calculates a motion vector of an X-direction component and a Y-direction component (a transverse-direction component and a height-direction component) which is defined between a current 1-frame image F1 and an immediately-preceding 1-frame image F2. The motion vector indicates the quantity and the direction of movement of the related image region. The motion vector may be replaced with a scalar motion quantity. The microcomputer 28 generates a pattern of calculated motion vectors for every 1-frame image represented by the image data. The microcomputer 28 refers to a current motion-vector pattern, and searches a current 1-frame image for an image region having the greatest motion vector. The microcomputer 28 recognizes the greatest-motion-vector image region as corresponding to the head of an occupant in the vehicle.

Specifically, the microcomputer 28 divides a current 1-frame image into image regions surrounded by contour lines. The image regions may be respective groups of lines. For each of the image regions, the microcomputer 28 calculates a motion vector of an X-direction component and a Y-direction component which is defined relative to the immediately-preceding 1-frame image. Thus, the microcomputer 28 generates a distribution (a pattern) of motion vectors related to the respective image regions in the current 1-frame image. A lot of long motion vectors collect in an image region corresponding to the occupant's head. On the other hand, a lot of short motion vectors collect in an image region corresponding to the occupant's body. The microcomputer 28 utilizes these facts, and decides the position of the occupant's head or the longitudinal-direction position of the occupant's head by use of the motion-vector distribution in a way similar to one of the previously-mentioned ways.

### Fifth Embodiment

A fifth embodiment of this invention is similar to the fourth embodiment thereof except for design changes mentioned hereafter.

According to the fifth embodiment of this invention, the microcomputer 28 defines a head-corresponding block and a body-corresponding block in a pattern (a distribution) of motion vectors related to a current 1-frame image. The microcomputer 28 disregards the magnitude of motion in deciding a head-corresponding block and a body-corresponding block. A rectangular image region which is small in size (horizontal width or transverse width) is decided as a head-corresponding block. On the other hand, a rectangular image region which is large in size (horizontal width or transverse width), and which extends below the head-corresponding block is defined as a body-corresponding block. The microcomputer 28 calculates the posture of an occupant in the vehicle and the position of the head of the occupant from the decided head-corresponding block and the body-corresponding block.

### Sixth Embodiment

A sixth embodiment of this invention is similar to one of the first, second, third, fourth, and fifth embodiments thereof except for design changes mentioned hereafter.

According to the sixth embodiment of this invention, the microcomputer 28 includes a combination of an input/output port, a CPU, a ROM, and a RAM. The microcomputer 28 operates in accordance with a control program stored in the ROM or the RAM.

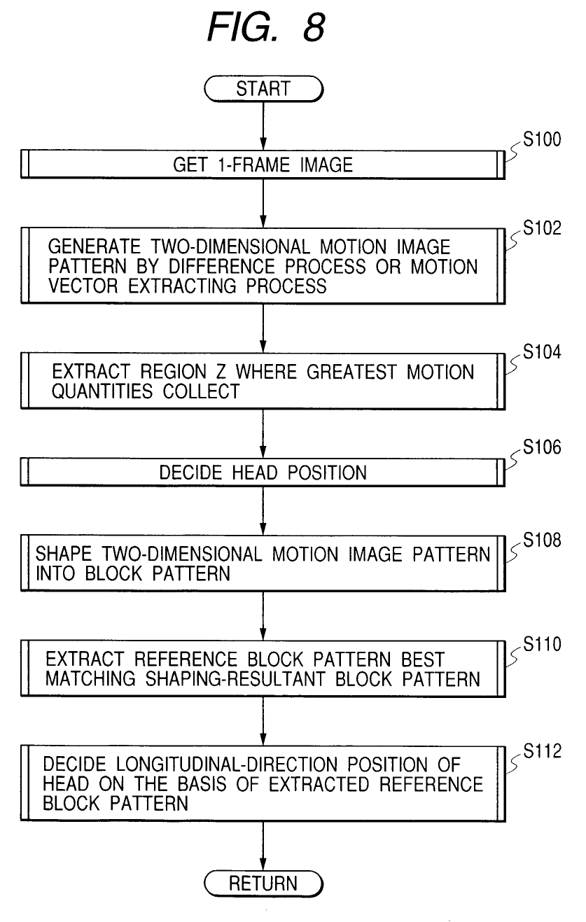

FIG. 8 is a flowchart of a segment of the control program for the microcomputer 28. The program segment of FIG. 8 is executed for every 1-frame image represented by the image data outputted from the comparator 26.

With reference to FIG. 8, a first step S100 of the program segment gets image data representative of a current 1-frame image. The step S100 stores the current 1-frame image data into the RAM for later use.

A step S102 following the step S100 retrieves data representative of a 1-frame image immediately preceding the current 1-frame image. The step S102 divides the current 1-frame image into image regions surrounded by contour lines. For each of the image regions, the step S102 calculates a motion vector of an X-direction component and a Y-direction component which is defined relative to the immediately-preceding 1-frame image. Thus, the step S102 generates a distribution (a pattern) of motion vectors related to the respective image regions in the current 1-frame image. The motion-vector distribution is also referred to as a two-dimensional motion image pattern.

Alternatively, the step S102 may calculate the difference between the current 1-frame image and the immediately-preceding 1-frame image to generate a difference 1-frame image usable as a two-dimensional motion image pattern.

A step S104 subsequent to the step S102 searches the two-dimensional motion image pattern for a region “Z” in which the greatest or substantially greatest motion quantities collect.

A step S106 following the step S104 calculates the geometric center point of the region “Z”. The step S106 concludes the calculated center point to be the position of the head of an occupant in the vehicle regarding the current 1-frame image.

A step S108 subsequent to the step S106 shapes the two-dimensional motion image pattern into a small rectangular block and a large rectangular block to generate a current block pattern. The small rectangular block corresponds to the head of the occupant. The large rectangular block extends below the small rectangular block, and corresponds to the body of the occupant.

The ROM or the RAM within the microcomputer 28 stores, in advance, data representing various reference patterns of a head-corresponding block and a body-corresponding block defined with respect to a typical occupant in the vehicle. The ROM or the RAM within the microcomputer 28 stores, in advance, data representing different postures of the upper part of the typical occupant which are assigned to the different reference block patterns (the different reference patterns of the head-corresponding block and the body-corresponding block) respectively.

A step S110 following the step S108 implements shape-similarity matching between the current block pattern and each of the reference block patterns. Specifically, the step S110 sequentially compares the shape of the current block pattern with the shapes of the reference block patterns, and decides one among the reference block patterns which best matches the current block pattern.

A step S112 subsequent to the step S110 detects the posture of the upper part of the typical occupant which is assigned to the best-match reference block pattern. The step S112 calculates the current longitudinal-direction position of the occupant's head from the detected posture of the upper part of the typical occupant.

After the step S112, the present execution cycle of the program segment ends.

### Seventh Embodiment

A seventh embodiment of this invention is similar to the sixth embodiment thereof except for design changes mentioned hereafter.

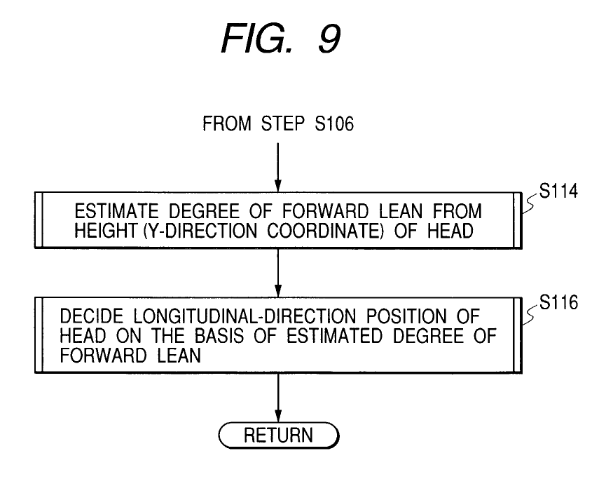

FIG. 9 is a flowchart of a portion of a control program for the microcomputer 28 in the seventh embodiment of this invention. The program portion in FIG. 9 includes steps S114 and S116 instead of the steps S108, S110, and S112 (see FIG. 8).

The step S114 follows the step S106 (see FIG. 8). The step S114 calculates the current Y-direction coordinate position (the current height position) of the occupant's head from the occupant's head position given by the step S106.

The ROM or the RAM within the microcomputer 28 stores, in advance, map data representing a predetermined relation between the height position of the head of a typical occupant in the vehicle and the degree of forward lean of the upper part of the typical occupant.

The step S114 estimates the current degree of forward lean of the upper part of the occupant from the current Y-direction coordinate position (the current height position) of the occupant's head by referring to the map data, that is, the previously-mentioned relation.

Previously, the microcomputer 28 estimates the height “h” of the upper part of the occupant from the detected highest coordinate position of the relatively-large detected image region corresponding to the occupant's head. The microcomputer 28 holds data representative of the estimated occupant's height “h”.

The step S116 which follows the step S114 calculates the current longitudinal-direction position of the occupant's head from the estimated occupant's height “h” and the estimated current degree of forward lean of the upper part of the occupant. After the step S116, the present execution cycle of a program segment ends.

### Eighth Embodiment

An eighth embodiment of this invention is similar to the sixth embodiment thereof except for design changes mentioned hereafter.

According to the eighth embodiment of this invention, the microcomputer 28 calculates the geometrical center point of the small rectangular block given by the step S108 (see FIG. 8). The microcomputer 28 concludes the calculated center point to be the position of the head of an occupant in the vehicle regarding the current 1-frame image.

What is claimed is:

1. An apparatus for detecting the head of an occupant in a seat within a vehicle, comprising:
an area image sensor for periodically taking an image of an area including the occupant in the seat, and outputting a signal sequentially representing 1-frame images of the area; and
a head position calculating section for deciding a position of a head of the occupant on the basis of the 1-frame images sequentially represented by the signal outputted by the area image sensor;
wherein the head position calculating section includes means for calculating motion quantities of portions of each of the 1-frame images, means for detecting, in each of the 1-frame images, a maximum-motion image region in which portions having substantially largest one among the calculated motion quantities collect to a highest degree, and means for recognizing the detected maximum-motion image region as corresponding to the head of the occupant.

2. An apparatus as recited in claim 1, wherein the head position calculating section includes means for calculating a difference between current one and immediately preceding one among the 1-frame images to generate a difference 1-frame image as an indication of the calculated motion quantities of portions of each of the 1-frame images, means for detecting a motion quantity distribution condition of the difference 1-frame image, and means for detecting the maximum-motion image region in response to the detected motion quantity distribution condition of the difference 1-frame image.

3. An apparatus as recited in claim 1, wherein the head position calculating section includes means for extracting image portions from each of the 1-frame images, means for calculating motion vectors regarding the extracted image portions respectively and defined between current one and immediately preceding one among the 1-frame images as an indication of the calculated motion quantities of portions of each of the 1-frame images, means for detecting a condition of a distribution of the calculated motion vectors over one frame, and means for detecting the maximum-motion image region in response to the detected motion vector distribution condition.

4. An apparatus as recited in claim 1, wherein the head position calculating section includes means for dividing and shaping a two-dimensional distribution pattern of the calculated motion quantities into an arrangement pattern of image blocks corresponding to respective portions of the occupant, means for collating the arrangement pattern with predetermined reference patterns corresponding to different occupant postures to detect which of the predetermined reference patterns the arrangement pattern best matches, and means for deciding a longitudinal-direction position of the head of the occupant in response to the predetermined reference pattern which best matches the arrangement pattern.

5. An apparatus as recited in claim 1, wherein the area image sensor is in front of the seat, and the head position calculating section includes means for deriving a height-direction position of the head of the occupant, means for deciding a degree of forward lean of the occupant in response to the derived height-direction position of the head of the occupant, and means for deciding a longitudinal-direction position of the head of the occupant in response to the decided degree of forward lean of the occupant.

6. An apparatus as recited in claim 1, wherein the head position calculating section includes means for averaging the calculated motion quantities into mean motion quantities over a prescribed number of successive frames according to a cumulative procedure, means for detecting a maximum-motion image region in which portions having substantially largest one among the mean motion quantities collect to a highest degree, and means for recognizing the detected maximum-motion image region as corresponding to the head of the occupant.

7. An apparatus for detecting the head of an occupant in a seat within a vehicle, comprising:
an area image sensor for periodically taking an image of an area including the occupant in the seat, and outputting a signal sequentially representing 1-frame images of the area; and
a head position calculating section for deciding a position of a head of the occupant on the basis of the 1-frame images sequentially represented by the signal outputted by the area image sensor;
wherein the head position calculating section includes means for calculating a difference between current one and immediately preceding one among the 1-frame images to generate a difference 1-frame image as an indication of a two-dimensional distribution pattern of the calculated motion quantities of portions of each of the 1-frame images, means for dividing and shaping the two-dimensional distribution pattern into an arrangement pattern of image blocks corresponding to respective portions of the occupant, means for collating the arrangement pattern with predetermined reference patterns corresponding to different occupant postures to detect which of the predetermined reference patterns the arrangement pattern best matches, and means for deciding a longitudinal-direction position of the head of the occupant in response to the predetermined reference pattern which best matches the arrangement pattern.

8. An apparatus for detecting the head of an occupant in a seat within a vehicle, comprising:
an area image sensor for periodically taking an image of an area including the occupant in the seat, and outputting a signal sequentially representing 1-frame images of the area; and
a head position calculating section for deciding a position of a head of the occupant on the basis of the 1-frame images sequentially represented by the signal outputted by the area image sensor;
wherein the head position calculating section includes means for extracting image portions from each of the 1-frame images, means for calculating motion vectors regarding the extracted image portions respectively and defined between current one and immediately preceding one among the 1-frame images, means for detecting a two-dimensional distribution pattern of the calculated motion vectors, means for dividing and shaping the two-dimensional distribution pattern into an arrangement pattern of image blocks corresponding to respective portions of the occupant, means for collating the arrangement pattern with predetermined reference patterns corresponding to different occupant postures to detect which of the predetermined reference patterns the arrangement pattern best matches, and means for deciding a longitudinal-direction position of the head of the occupant in response to the predetermined reference pattern which best matches the arrangement pattern.

9. An apparatus as recited in claim 2, wherein the head position calculating section includes means for averaging a prescribed number of successive difference 1-frame images into a mean difference 1-frame image according to a cumulative procedure, means for detecting a motion quantity distribution condition of the mean difference 1-frame image, and means for detecting the maximum-motion image region in response to the detected motion quantity distribution condition of the mean difference 1-frame image.

10. An apparatus as recited in claim 3, wherein the head position calculating section includes means for averaging the calculated motion vector into mean motion vectors over a prescribed number of successive frames according to a cumulative procedure, means for detecting a condition of a distribution of the mean motion vectors over one frame, and means for detecting the maximum-motion image region in response to the detected mean motion vector distribution condition.
